(19) United States
(12) Patent Application Publication
(10) Pub. No.: US 2023/0336702 A1
(43) Pub. Date: Oct. 19, 2023

(54) PROCESSING DEVICE, PROCESSING SYSTEM, AND PROCESSING METHOD

(71) Applicant: NEC Corporation, Minato-ku, Tokyo (JP)

(72) Inventors: Akira TSUJI, Tokyo (JP); Jiro Abe, Tokyo (JP)

(73) Assignee: NEC Corporation, Minato-ku, Tokyo (JP)

(21) Appl. No.: 18/028,448

(22) PCT Filed: Oct. 6, 2020
(86) PCT No.: PCT/JP2020/037885

§ 371 Date: Mar. 24, 2023

(51) Int. Cl. H04N 13/117; G06T 17/00; H04N 13/279; G06V 10/25; G06F 3/01

(52) U.S. Cl. CPC H04N 13/117; G06T 17/00; H04N 13/279; G06V 10/25; G06F 3/013

(57) ABSTRACT

Provided are a processing device, a processing system, a processing method, and a program capable of improving visibility when displaying image data and three-dimensional data. A processing device includes: an image data input means to which image data is input; an image data acquisition information input means to which image data acquisition information is input; a three-dimensional data input means to which three-dimensional data is input; a viewpoint image generation means for generating a viewpoint image that projects the three-dimensional data on the basis of a position and a shooting direction of a shooting means; a target area extraction means for matching the image data with the viewpoint image and extracting a target area corresponding to the image data in the viewpoint image; and a parameter generation means for generating parameters for displaying the target area.

### TECHNICAL FIELD

The present invention relates to a processing device, a processing system, a processing method, and a non-transitory computer readable medium storing a program.

### BACKGROUND ART

Patent Literature 1 describes a position recognition system. The position recognition system of Patent Literature 1 extracts a plurality of two-dimensional images with viewpoints and line-of-sight direction vectors attached to point cloud data acquired by a three-dimensional scanner such as light detection and ranging (LiDAR). Then, by matching feature points between the extracted two-dimensional image and the camera image of the object, the position of the object corresponding to the camera image on the point cloud data is identified.

### CITATION LIST

### Patent Literature

Patent Literature 1: Japanese Unexamined Patent Application Publication No. 2018-077837

### SUMMARY OF INVENTION

### Technical Problem

In the position recognition system of Patent Literature 1, point cloud data is converted into image data from various viewpoints and angles of view in advance, and this data is matched with the image data to be processed. Therefore, the point cloud image generation causes problems such as storage area compression. As drones and crawlers (ground mobile robots) become more widely used for surveillance, the amount of data to be acquired will increase, and this problem will become more pronounced.

An object of the present disclosure is to solve such a problem, and to provide a processing device, a processing system, a processing method, and a non-transitory computer readable medium storing a program, which can improve visibility when displaying image data and three-dimensional data while suppressing storage area usage.

### Solution to Problem

A processing device according to the present disclosure, including: an image data input means to which image data acquired by a shooting means for shooting a display object is input; an image data acquisition information input means to which image data acquisition information when the image data is acquired is input; a three-dimensional data input means to which three-dimensional data acquired by a scanning means for scanning the display object is input; a viewpoint image generation means for generating a viewpoint image by determining a position and line-of-sight direction of a viewpoint in the three-dimensional data based on the position and shooting direction of the shooting means in the image data acquisition information, and generating a viewpoint image that projects the three-dimensional data onto a surface orthogonal to the line-of-sight direction; a target area extraction means for matching the image data with the viewpoint image and extracting a target area corresponding to the image data in the viewpoint image; and a three-dimensional data display parameter generation means for generating parameters for displaying the target area.

The processing system according to the present disclosure also includes a three-dimensional data acquisition device that acquires the three-dimensional data by the scanning means for scanning the display object, and the processing device described above.

Furthermore, the processing method according to the present disclosure includes: inputting image data acquired by a shooting means for shooting a display object; inputting image data acquisition information when the image data is acquired; inputting three-dimensional data acquired by a scanning means for scanning the display object; determining a position and line-of-sight direction of a viewpoint in the three-dimensional data based on the position and shooting direction of the shooting means in the image data acquisition information and generating a viewpoint image that projects the three-dimensional data onto a surface orthogonal to the line-of-sight direction; matching the image data with the viewpoint image and extracting a target area corresponding to the image data in the viewpoint image; and generating parameters for displaying the target area.

Furthermore, the program according to the present disclosure causes a computer to execute: inputting image data acquired by a shooting means for shooting a display object; inputting image data acquisition information when the image data is acquired; inputting three-dimensional data acquired by a scanning means for scanning the display object; determining a position and line-of-sight direction of a viewpoint in the three-dimensional data based on the position and shooting direction of the shooting means in the image data acquisition information and generating a viewpoint image that projects the three-dimensional data onto a surface orthogonal to the line-of-sight direction; matching the image data with the viewpoint image and extracting a target area corresponding to the image data in the viewpoint image; and generating parameters for displaying the target area.

### Advantageous Effects of Invention

The present disclosure provides a processing device, a processing system, a processing method, and a non-transitory computer readable medium storing a program, which can improve visibility when displaying image data and three-dimensional data while suppressing storage area usage.

### BRIEF DESCRIPTION OF DRAWINGS

FIG. 1 is a block diagram illustrating a processing device according to a first example embodiment.

FIG. 2 is a block diagram illustrating another processing device according to the first example embodiment.

FIG. 3 is a diagram illustrating image data input to an image data input unit in the processing device according to the first example embodiment.

FIG. 4 is a diagram illustrating image data acquisition information input to an image data acquisition information input unit in the processing device according to the first example embodiment.

FIG. 5 is a diagram illustrating three-dimensional data input to a three-dimensional data input unit in the processing device according to the first example embodiment.

FIG. 6 is a diagram illustrating a three-dimensional data acquisition device that acquires three-dimensional data in the processing device according to the first example embodiment.

FIG. 7 is a diagram illustrating the viewpoint image generated by a viewpoint image generation unit and a target area extracted by a target area extraction unit in the processing device according to the first example embodiment.

FIG. 8 is a diagram illustrating image data and a target area in the processing device according to the first example embodiment.

FIG. 9 is a diagram illustrating the display unit in another processing device according to the first example embodiment.

FIG. 10 is a block diagram illustrating still another processing device according to the first example embodiment.

FIG. 11 is a flowchart illustrating a processing method using the processing device according to the first example embodiment.

FIG. 12 is a flowchart illustrating a processing method using another processing device according to the first example embodiment.

### EXAMPLE EMBODIMENT

Hereinafter, example embodiments will be described with reference to the drawings. For clarity of description, in the following description and figures, omission and simplification are made as appropriate. In the figures, the same elements are denoted by the same reference numerals, and redundant description is omitted as necessary.

### First Example Embodiment

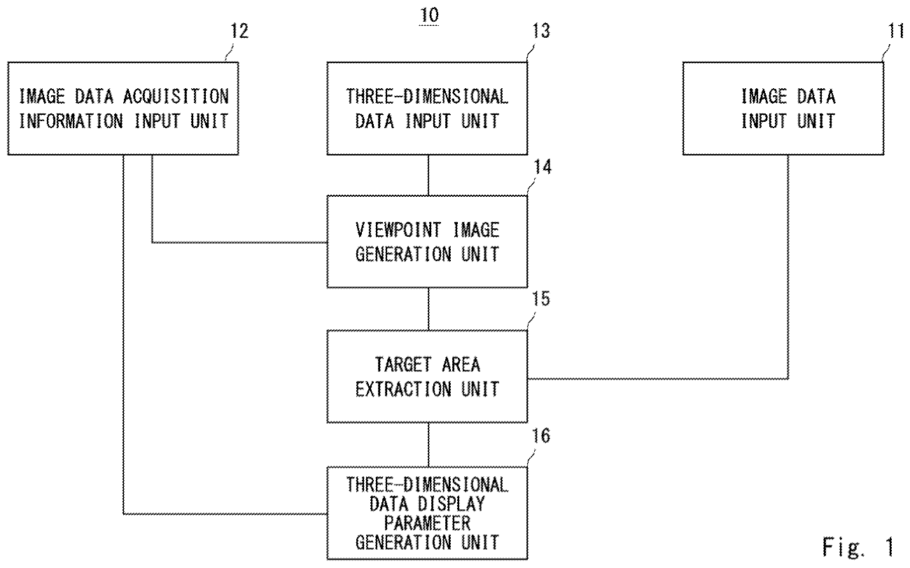

A processing device according to the first example embodiment will be described. FIG. 1 is a block diagram illustrating a processing device according to the first example embodiment. As illustrated in FIG. 1, the processing device includes an image data input unit 11, an image data acquisition information input unit 12, a three-dimensional data input unit 13, a viewpoint image generation unit 14, a target area extraction unit 15, and a three-dimensional data display parameter generation unit 16. The image data input unit 11, image data acquisition information input unit 12, three-dimensional data input unit 13, viewpoint image generation unit 14, target area extraction unit 15, and three-dimensional data display parameter generation unit 16 function as image data input means, image data acquisition information input means, three-dimensional data input means, viewpoint image generation means, target area extraction means, and three-dimensional data display parameter generation means, respectively.

The processing device 10 may be composed of hardware including, for example, a microcomputer including a central processing unit (CPU), a read only memory (ROM), a random access memory (RAM), and an interface unit (I/F). The CPU and others function as the viewpoint image generation unit 14, target area extraction unit 15, and three-dimensional data display parameter generation unit 16, and execute processing such as data generation, data extraction, and control. It may execute data display processing as a data display function. The ROM stores data generation programs, data extraction programs, data display programs, and control programs executed by the CPU. RAM stores various types of data such as image data and three-dimensional data. The interface unit (I/F) inputs and outputs signals to and from the outside. The CPU, ROM, RAM, and interface unit are connected to each other via a data bus or other means.

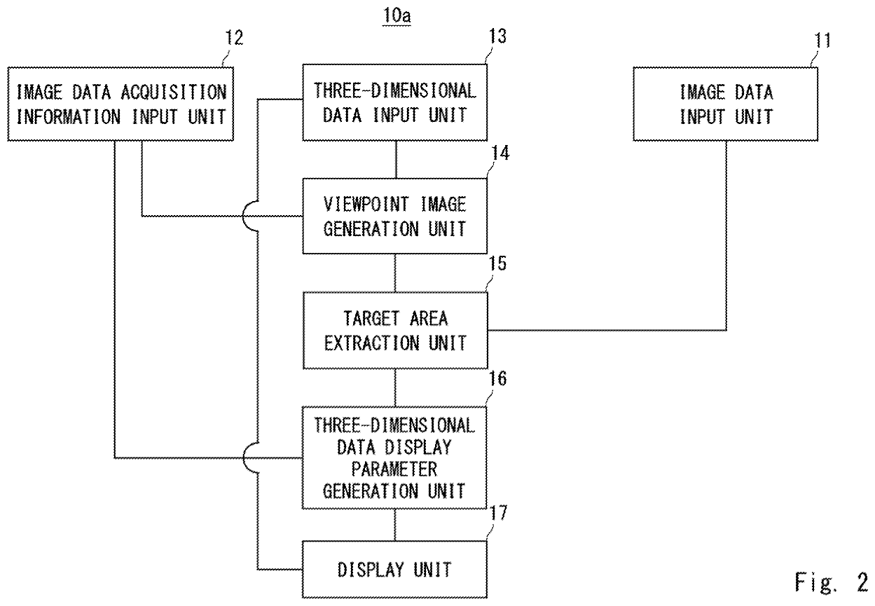

FIG. 2 is a block diagram illustrating another processing device according to the first example embodiment. As illustrated in FIG. 2, a processing device 10a further includes a display unit 17. The display unit 17 functions as a display means. The following is a description of the configurations of the processing devices 10 and 10a.

<Image Data Input Unit>

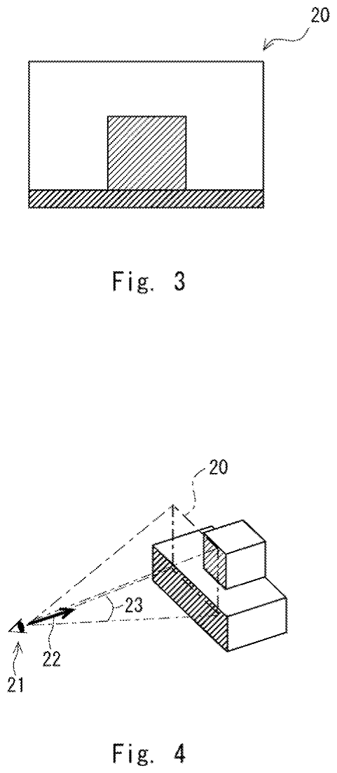

FIG. 3 is a diagram illustrating image data input to the image data input unit 11 in the processing device 10 according to the first example embodiment. As illustrated in FIG. 3, image data 20 is input to the image data input unit 11. The image data 20 is data acquired by a shooting means for shooting the display object. The shooting means is, for example, a camera. In this case, the image data 20 is data of still images captured by the camera. The image data 20 may be a single frame of video captured by the camera. The image data 20 includes images to be displayed. The display object is, for example, a facility to be monitored.

The image data input unit 11 may receive the image data 20 from the image data holding unit described below. The image data input unit 11 may receive the image data 20 directly from a shooting means such as a camera.

<Image Data Acquisition Information Input Unit>

FIG. 4 is a diagram illustrating image data acquisition information input to the image data acquisition information input unit 12 in the processing device 10 according to the first example embodiment. As illustrated in FIG. 4, image data acquisition information is input to the image data acquisition information input unit 12. The image data acquisition information is information on when the image data 20 input to the image data input unit 11 is acquired. The image data acquisition information includes, for example, a position 21 of the shooting means, a shooting direction 22, and an angle of view 23 at the time of shooting. The shooting direction 22 may be represented as a shooting direction vector indicating the shooting direction. The angle of view 23 at the time of shooting includes, for example, an angle of view 23 in the vertical direction. In a case where the shooting means is not parallel to a reference plane, such as the ground, the image data acquisition information may include tilt sensor information.

The image data acquisition information input unit 12 may receive image data acquisition information from the image data acquisition information holding unit described later. The image data acquisition information input unit 12 may receive image data acquisition information directly from a shooting means such as a camera.

<Three-Dimensional Data Input Unit>

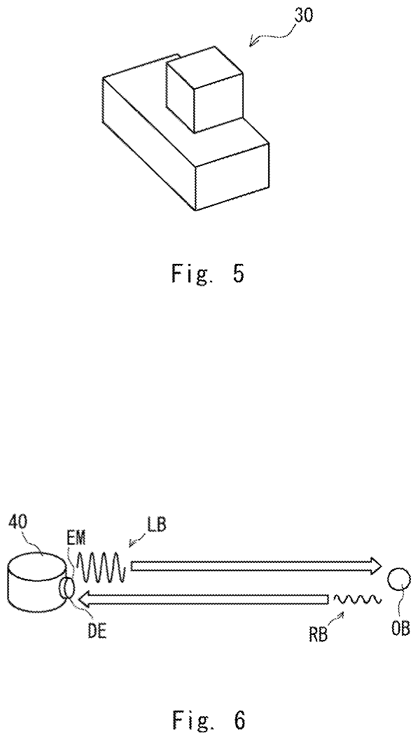

FIG. 5 is a diagram illustrating three-dimensional data input to the three-dimensional data input unit 13 in the processing device 10 according to the first example embodiment. As illustrated in FIG. 5, three-dimensional data 30 is input to the three-dimensional data input unit 13. The three-dimensional data 30 is data acquired by a scanning means for scanning the display object. The scanning means is a three-dimensional data acquisition device that acquires three-dimensional data such as LiDAR. In that case, the three-dimensional data is point cloud data.

FIG. 6 is a diagram illustrating a three-dimensional data acquisition device that acquires three-dimensional data in the processing device 10 according to the first example embodiment. As illustrated in FIG. 6, the three-dimensional data acquisition device may be a LiDAR 40. The LiDAR 40 can scan a beam LB such as laser light against a measurement object OB to acquire the shape of the measurement object OB as point cloud data. Thus, the LiDAR 40 can measure the distance to the measurement object OB and the shape of the measurement object OB. The point cloud data includes at least coordinate values and luminance values.

For example, the principle of the ToF (time of flight) LiDAR 40 is as follows. That is, the LiDAR 40 has a light emitting unit EM that emits a beam LB such as laser light, and a detection unit DE that detects the reflected light RB reflected by the beam LB at the measurement object OB. The LiDAR 40 detects the reflected light RB reflected by the measurement object OB while scanning the beam LB against the measurement object OB at a predetermined angle of view. Then, the LiDAR 40 calculates the distance D to the measurement object OB from D=(t2−t1)/2×(speed of light), in which t1 is the time until the beam LB reaches the measurement object OB, and t2 is the time until the reflected light RB reaches the detection unit DE. As a result, the LiDAR 40 can acquire the point cloud data having the coordinate value and the luminance value including the distance to the measurement object OB as the scan data in the scanned range.

The three-dimensional data 30 includes the shape data of the display object acquired by the LiDAR 40, and may further include additional information such as luminance information. When a plurality of three-dimensional data 30 are acquired from a plurality of positions, it is desirable to integrate the plurality of three-dimensional data 30. For example, in a case where the three-dimensional data 30 is acquired from a plurality of points in the facility to be monitored, it is desirable to align and integrate these data in advance. The three-dimensional data 30 may be associated with parameters for conversion to a world coordinate system.

The three-dimensional data input unit 13 may receive the three-dimensional data 30 from a storage device such as a three-dimensional data holding unit described later. The three-dimensional data input unit 13 may receive the three-dimensional data 30 directly from a three-dimensional data acquisition device such as the LiDAR 40.

<Viewpoint Image Generation Unit>

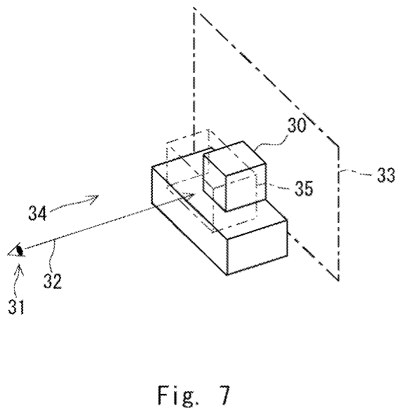

FIG. 7 is a diagram illustrating the viewpoint image generated by the viewpoint image generation unit 14 and the target area extracted by the target area extraction unit 15 in the processing device 10 according to the first example embodiment. As illustrated in FIG. 7, the viewpoint image generation unit 14 generates a viewpoint image 34. In order to generate the viewpoint image 34, the viewpoint image generation unit 14 first determines the position 31 of the viewpoint and the line-of-sight direction 32 in the three-dimensional data 30 on the basis of the position 21 of the shooting means and the shooting direction 22 in the image data acquisition information. Then, the viewpoint image generation unit 14 projects the three-dimensional data 30 onto a surface 33 orthogonal to the line-of-sight direction 32. The viewpoint image 34 is a projection of the three-dimensional data 30 on the surface 33. In this manner, the viewpoint image generation unit 14 generates the viewpoint image 34. In a case where the plurality of pieces of three-dimensional data 30 is input in an unintegrated state, the three-dimensional data, which is taken near the position 21 where the image data 20 was taken and includes data in the shooting direction 22, may be selected.

<Target Area Extraction Unit>

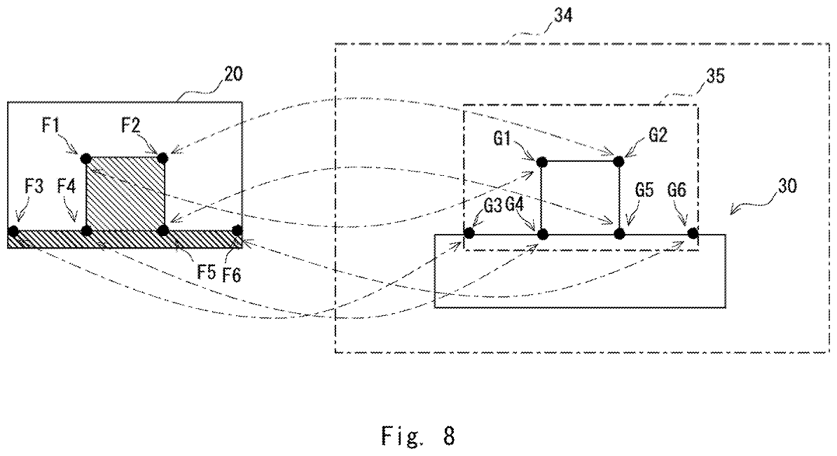

FIG. 8 is a diagram illustrating the image data 20 and the target area 35 in the processing device 10 according to the first example embodiment. As illustrated in FIGS. 7 and 8, the target area extraction unit 15 extracts the target area 35 corresponding to the image data 20 in the viewpoint image 34. In order to extract the target area 35, the target area extraction unit 15 first matches the image data 20 with the viewpoint image 34. For example, the target area extraction unit 15 executes matching of the feature points F1 to F6 and G1 to G6 between the image data 20 and the viewpoint image 50. Specifically, the target area extraction unit 15 extracts feature points G1 to G6 having similar features to the feature points F1 to F6 in the image data 20 from the viewpoint image 34. Then, the target area extraction unit 15 extracts the target area 35 corresponding to the image data 20 from the three-dimensional data 30. As illustrated in FIGS. 7 and 8, the target area 35 includes horizontal and vertical ranges orthogonal to the line-of-sight direction 32 and a depth range along the line-of-sight direction 32, as illustrated in FIG. 7. The matching is performed, for example, by feature point matching.

<Three-Dimensional Data Display Parameter Generation Unit>

The three-dimensional data display parameter generation unit 16 generates parameters for displaying the range of the target area 35 in the three-dimensional data 30. Specifically, the three-dimensional data display parameter generation unit 16 generates parameters for displaying the target area 35 on the display unit 17. The parameters include image data acquisition information, information on screen settings of a display screen on which the display unit 17 displays the target area 35, and information on the range of the target area 35.

The parameters include, for example, the width of the graphical user interface (GUI) screen, the height of the GUI screen, the coordinates of the sensors such as the shooting means and scanning means in the world coordinate system, the shooting direction vector of the shooting means, the line-of-sight direction vector of the scanning means, the vector indicating the upward direction of the sensors, the display range in the depth direction (front side), the display range in the depth direction (back side), and the angle formed by the screen height with the focal point (field of view: FOV). The parameters may include camera parameters from a point cloud library (PCL).

In the coordinates of a sensor in the world coordinate system, the world coordinate system is a coordinate system common to those existing within some range. It is, for example, a common coordinate system for all sensors (LiDAR and cameras) installed in infrastructure facilities. It is also, for example, a coordinate system (including latitude, longitude, and altitude) common to the entire globe.

The LiDAR 40 generally acquires the three-dimensional data 30 in a local coordinate system having the origin at the point of measurement. In a case where the measurement is performed at a plurality of places in a facility, the coordinate systems of the three-dimensional data 30 are different from each other, but it is preferable to convert the local coordinate system of each LiDAR 40 to the world coordinate system through the use of a global positioning system (GPS) or a beacon.

It is preferable that the camera can determine its shooting position in the world coordinate system through linkage with GPS and beacons. A world coordinate system with the position of a specific LiDAR 40 as the origin may be used, in which case the three-dimensional data 30 acquired by each LiDAR 40 can be aligned with each other and each three-dimensional data 30 can be converted to data in the world coordinate system.

In the FOV, in the case of the LiDAR 40, the focal point may be the origin of the LiDAR 40 coordinate system.

The followings are examples of parameters and means of acquiring parameters. That is, the width and height of the GUI screen may be acquired from display system settings. The coordinates of the sensors such as shooting and scanning means in the world coordinate system may be acquired from GPS or other means for enabling handling of the world coordinate system. The shooting direction vector of the shooting means may be acquired from the shooting direction of the camera or other shooting means. The line-of-sight direction vector of the scanning means may be acquired from the shooting direction vector. The vector indicating the upward direction of the sensor may be acquired from the orientation of the LiDAR 40 during measurement, estimation of the acquired point cloud data (for example, extracting the ground and assuming a vertical direction with respect to it). The display range in the depth direction (front) may be acquired by matching the point cloud image generated from the point cloud data with the camera image and extracting the point cloud data corresponding to the target area of the point cloud image with the smallest depth direction coordinates from the LiDAR 40. The display range in the depth direction (back) may be acquired in the same manner as above, by extracting the largest depth coordinates from the LiDAR. The angle formed by the screen height with the focal point may be acquired from the FOV of the camera image.

<Display Unit>

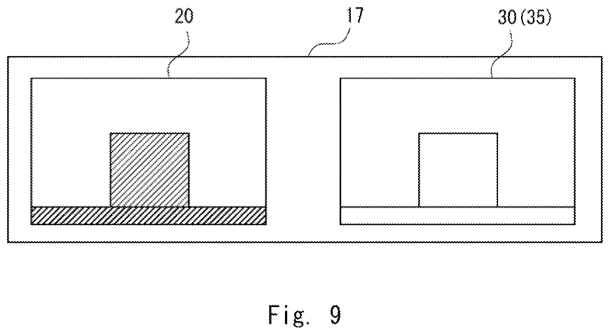

FIG. 9 is a diagram illustrating the display unit 17 in another processing device 10a according to the first example embodiment. As illustrated in FIG. 9, the display unit 17 displays the three-dimensional data 30 according to the parameters. Specifically, the display unit 17 displays the target area 35 extracted by the target area extraction unit 15 out of the three-dimensional data 30. The display unit 17 may display the three-dimensional data 30 alongside the image data 20.

The display unit 17 may display the three-dimensional data 30 in synchronization with the image data 20. For example, in a case where predetermined frames of video captured by the shooting means are input to the image data input unit 11 at predetermined intervals, the display unit 17 may display the target area 35 corresponding to the image data 20 in synchronization with the timing of the display of the image data 20 of the predetermined frames.

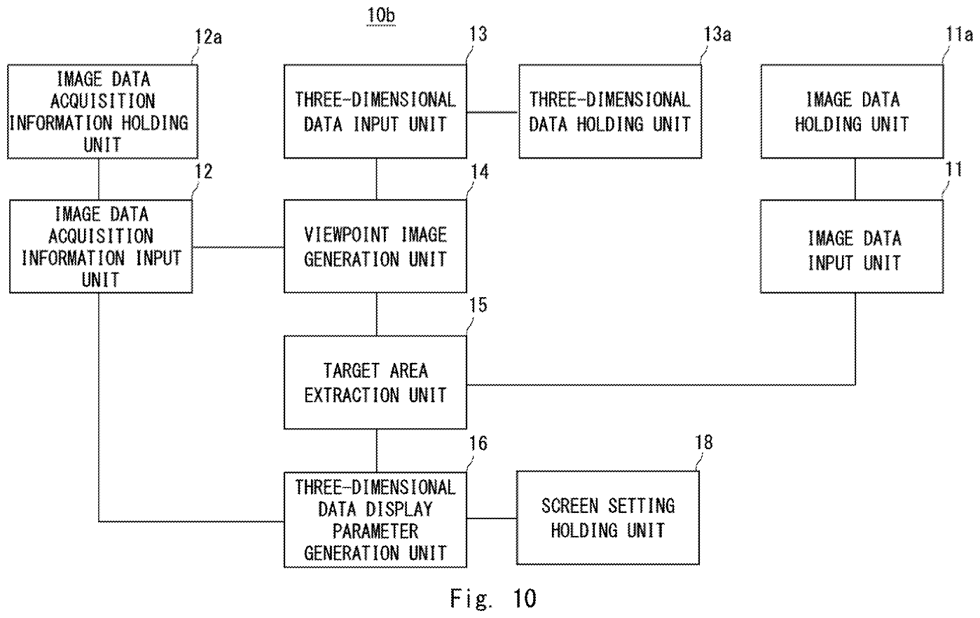

FIG. 10 is a block diagram illustrating still another processing device according to the first example embodiment. As illustrated in FIG. 10, the processing device 10b may further include an image data holding unit 11a, an image data acquisition information holding unit 12a, a three-dimensional data holding unit 13a, and a screen setting holding unit 18. The image data holding unit 11a, image data acquisition information holding unit 12a, three-dimensional data holding unit 13a, and screen setting holding unit 18 function as image data holding means, image data acquisition information holding means, three-dimensional data holding means, and screen setting holding means, respectively.

The processing device 10b may include only some of the image data holding unit 11a, image data acquisition information holding unit 12a, three-dimensional data holding unit 13a, and screen setting holding unit 18. The image data holding unit 11a, image data acquisition information holding unit 12a, three-dimensional data holding unit 13a, and screen setting holding unit 18 may each be provided independently of the processing device 10 as stand-alone functional storage devices. The processing device 10b may further include a display unit 17.

<Image Data Holding Unit>

The image data holding unit 11a holds the image data 20. As long as the image data holding unit 11a holds the image data 20 acquired by a shooting means for shooting the display object, it may hold other pieces of image data 20. The image data holding unit 11a may, for example, acquire the image data 20 from a camera or other shooting means, or may acquire the image data 20 from other holding means that holds the image data 20. The image data 20 held in the image data holding unit 11a is input to the image data input unit 11 from the image data holding unit 11a.

<Image Data Acquisition Information Holding Unit>

The image data acquisition information holding unit 12a holds image data acquisition information. The image data acquisition information holding unit 12a may hold other image data acquisition information as long as it holds the image data acquisition information when the image data 20 is acquired. For example, the image data acquisition information holding unit 12a may acquire the image data acquisition information from a shooting means such as a camera, or may acquire the image data acquisition information from another holding unit holding the image data acquisition information. The image data acquisition information is input from the image data acquisition information holding unit 12a to the image data acquisition information input unit 12.

<Three-Dimensional Data Holding Unit>

The three-dimensional data holding unit 13a holds the three-dimensional data 30. As long as the three-dimensional data holding unit 13a holds the three-dimensional data 30 acquired by a scanning means for scanning the display object, it may hold other pieces of three-dimensional data 30. For example, the three-dimensional data holding unit 13a may acquire the three-dimensional data from a three-dimensional data acquisition device that acquires the three-dimensional data 30 by a scanning means for scanning a display object, or may acquire the three-dimensional data 30 from another holding unit that holds the three-dimensional data 30. The three-dimensional data 30 is input to the three-dimensional data input unit 13 from the three-dimensional data holding unit 13a.

<Screen Setting Holding Unit>

The screen setting holding unit 18 holds the screen setting information of the display screen on which the display unit 17 displays the target area 35. The screen setting information includes the height and width of the display screen for displaying the three-dimensional data 30. The above parameters may include screen setting information.

<Processing Method>

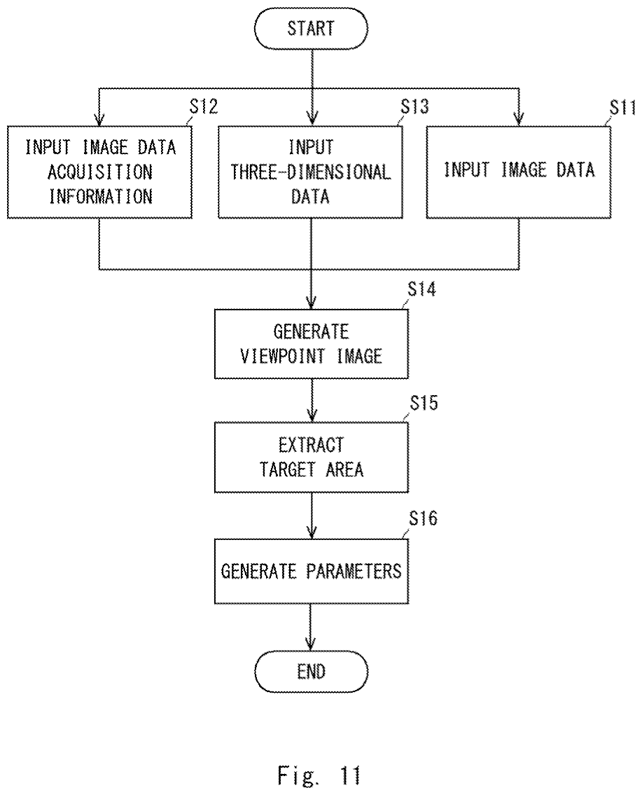

Next, the processing method using the processing device 10 according to the present example embodiment will be described. FIG. 11 is a flowchart illustrating a processing method using the processing device 10 according to the first example embodiment.

As illustrated in step S11 in FIG. 11 and FIG. 3, the image data 20 is input. The image data 20 acquired by, for example, a shooting means for shooting the display object is input to the image data input unit 11. The image data 20 may be held in the image data holding unit 11a, and the held image data 20 may be input to the image data input unit 11.

As illustrated in step S12 and FIG. 4, the image data acquisition information is input. For example, the image data acquisition information when the image data 20 is acquired is input to the image data acquisition information input unit 12. The image data acquisition information may be held in the image data acquisition information holding unit 12a and the held image data acquisition information may be input to the image data acquisition information input unit 12.

As illustrated in step S13 and FIG. 5, the three-dimensional data 30 is input. For example, the three-dimensional data 30 acquired by a scanning means for scanning the display object is input to the three-dimensional data input unit 13. The three-dimensional data 30 may be held in the three-dimensional data holding unit 13a and the held three-dimensional data 30 may be input to the three-dimensional data input unit 13.

Steps S11, S12, and S13 are not necessarily in this order. For example, they may be in the order of step S13, step S11, step S12, or any other order.

Next, as illustrated in step S14 and FIG. 7, the viewpoint image 34 is generated. For example, the viewpoint image generation unit 14 determines the position 31 and line-of-sight direction 32 of the viewpoint in the three-dimensional data 30 based on the position 21 of the shooting means and the shooting direction 22 in the image data acquisition information. Then, the viewpoint image generation unit 14 generates the viewpoint image 34 that projects the three-dimensional data 30 onto a surface 33 orthogonal to the line-of-sight direction 32.

Next, as illustrated in step S15 and FIGS. 7 and 8, the target area 35 is extracted. For example, the target area extraction unit 15 matches the image data 20 with the viewpoint image 34 and extracts the target area 35 corresponding to the image data 20 in the viewpoint image 34. The target area 35 may include horizontal and vertical ranges orthogonal to the line-of-sight direction 32, as well as a depth range along the line-of-sight direction 32.

Next, as illustrated in step S16, parameters are generated. For example, the three-dimensional data display parameter generation unit 16 generates parameters for displaying the target area 35. In this manner, the processing device 10 can generate display parameters.

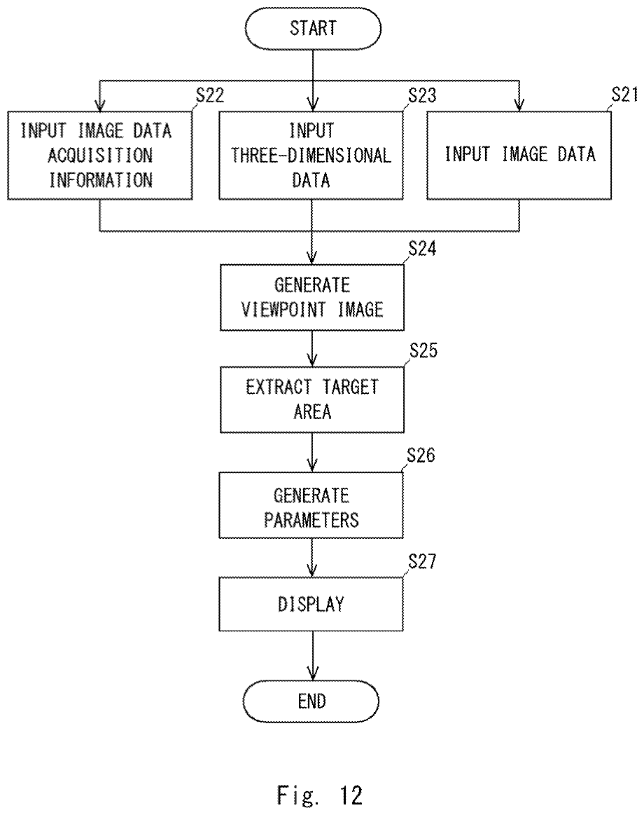

Next, the processing method of displaying on the display unit 17 using display parameters will be described. FIG. 12 is a flowchart illustrating the processing method using another processing device 10a according to the first example embodiment. Steps S21 to 26 in FIG. 12 are the same as steps S11 to 16 in FIG. 11.

As illustrated in step S27 and FIG. 9, the target area 35 in the three-dimensional data 30 is displayed. For example, the display unit 17 displays the three-dimensional data 30 according to the parameters. When displaying the three-dimensional data 30 according to the parameters, the three-dimensional data may be displayed alongside the image data 20. The display unit 17 may display the three-dimensional data 30 in synchronization with the image data 20 when displaying the three-dimensional data 30 according to the parameters. In this manner, the processing device 10a can display the three-dimensional data 30 on the display unit 17.

Next, effects of the processing device 10 of the present example embodiment will be described. The processing devices 10a and 10b are also included and referred to as processing device 10. The processing device 10 of the present example embodiment generates the target area 35 from which the three-dimensional data 30 corresponding to the image data 20 is extracted. Then, the processing device 10 displays the target area 35. Therefore, the three-dimensional data can be generated and displayed at the same angle and angle of view as the image data, thus improving visibility when displaying the image data 20 and three-dimensional data 30.

For example, in facility monitoring of electric power facilities or the like, in addition to cameras, a three-dimensional data acquisition device such as the LiDAR 40 could be used to acquire data for monitoring. The camera acquires two-dimensional RGB data (image data 20), and the LiDAR 40 acquires point cloud data (three-dimensional data 30). The camera and LiDAR 40 have different parameters related to the measurement range, such as angle of view.

The processing device 10 of the present example embodiment extracts the three-dimensional data 30 corresponding to the display object or range indicated by the image data 20. In addition, the processing device 10 of the present example embodiment displays the three-dimensional data 30 at the same angle and angle of view as those of the camera. Therefore, the person in charge of facility monitoring can display the three-dimensional data 30 corresponding to the image data 20, allowing him or her to check the condition of the facility to be monitored with good visibility.

The processing device 10 may display the three-dimensional data 30 alongside the image data 20 or in synchronization with the image data 20. This further improves the visibility of the image data 20 and the three-dimensional data 30.

The processing device 10 of the present example embodiment extracts the target area 35 corresponding to the image data 20 from the input three-dimensional data 30. Therefore, it is not necessary to prepare in advance the three-dimensional data 30 converted into image data from various viewpoint positions 31 and line-of-sight directions 32 to correspond to the image data 20 taken from various shooting positions 21 and shooting directions 22. This suppresses the storage area usage.

By having the image data 20, image data acquisition information, three-dimensional data 30, and screen setting information held in the image data holding unit 11a, image data acquisition information holding unit 12a, three-dimensional data holding unit 13a, and screen setting holding unit 18, the storage area usage can be further suppressed.

### Second Example Embodiment

Next, the processing system according to the second example embodiment will be described. The processing system includes the above-described processing device 10 (the processing devices 10a and 10b are also included and referred to as processing device 10) and a three-dimensional data acquisition unit. The three-dimensional data acquisition unit functions as a three-dimensional data acquisition means. The three-dimensional data acquisition unit includes a scanning means and acquires three-dimensional data by the scanning means for scanning the display object. The three-dimensional data acquisition unit is, for example, a LiDAR 40. In this case, the three-dimensional data is point cloud data acquired by the LiDAR 40 as a display object. The processing method according to the present example embodiment is the processing method of the first example embodiment which further includes a step of causing a scanning means for scanning the display object to acquire the three-dimensional data 30.

Since the processing system according to the present example embodiment includes the three-dimensional data acquisition unit in addition to the processing device 10, it can display the three-dimensional data 30 of the display object located at the desired location. Other configurations and effects are included in the description of the first example embodiment.

Although the present invention has been described above with reference to the first and second example embodiments, the present invention is not limited to the above first and second example embodiments. Various modifications that can be understood by those skilled in the art can be made to the configuration and details of the present invention within the scope of the present invention. For example, an example embodiment combining the respective configurations of the first and second example embodiments is also included in the scope of the technical concept. A program for causing a computer to execute the processing methods of the first and second example embodiments is also included in the technical scope of the first and second example embodiments.

Some or all of the above example embodiments may be described as the following supplementary notes, but are not limited to the following.

(Supplementary note 1)

A processing device including:
an image data input means to which image data acquired by a shooting means for shooting a display object is input;
an image data acquisition information input means to which image data acquisition information when the image data is acquired is input;
a three-dimensional data input means to which three-dimensional data acquired by a scanning means for scanning the display object is input;
a viewpoint image generation means for generating a viewpoint image by determining a position and line-of-sight direction of a viewpoint in the three-dimensional data based on the position and shooting direction of the shooting means in the image data acquisition information, and generating a viewpoint image that projects the three-dimensional data onto a surface orthogonal to the line-of-sight direction;
a target area extraction means for matching the image data with the viewpoint image and extracting a target area corresponding to the image data in the viewpoint image; and
a three-dimensional data display parameter generation means for generating parameters for displaying the target area.

(Supplementary note 2)

The processing device according to Supplementary note 1, further including a display means for displaying the three-dimensional data according to the parameters.

(Supplementary note 3)

The processing device according to Supplementary note 2, in which the display means displays the three-dimensional data alongside the image data.

(Supplementary note 4)

The processing device according to Supplementary note 2 or 3, in which the display means displays the three-dimensional data in synchronization with the image data.

(Supplementary note 5)

The processing device according to any one of Supplementary notes 2 to 4, in which
the display means further includes a screen setting holding means for holding screen setting information of the display screen on which the target area is displayed by a display means, and
the parameters include the screen setting information.

(Supplementary note 6)

The processing device according to any one of Supplementary notes 1 to 5, in which the target area includes horizontal and vertical ranges orthogonal to the line-of-sight direction, as well as a depth range along the line-of-sight direction.

(Supplementary note 7)

The processing device according to any one of Supplementary notes 1 to 6, further including an image data holding means for holding the image data,
in which the image data is input to the image data input means from the image data holding means.

(Supplementary note 8)

The processing device according to any one of Supplementary notes 1 to 7, further including an image data acquisition information holding means for holding the image data acquisition information,
in which the image data acquisition information is input to the image data acquisition information input means from the image data acquisition information holding means.

(Supplementary note 9)

The processing device according to any one of Supplementary notes 1 to 8, further including a three-dimensional data holding means for holding the three-dimensional data,
in which the three-dimensional data is input to the three-dimensional data input means from the three-dimensional data holding means.

(Supplementary note 10)

The processing device according to any one of Supplementary notes 1 to 9, in which the parameters include at least one of: a width of a GUI screen, a height of the GUI screen, coordinates of the shooting and scanning means in a world coordinate system, a shooting direction vector of the shooting means, a line-of-sight direction vector of the scanning means, a vector indicating an upward direction of the shooting and scanning means, a display range in a depth direction, and FOV.

(Supplementary note 11)

A processing system including:
a three-dimensional data acquisition device configured to acquire the three-dimensional data by the scanning means for scanning the display object; and
the processing device according to any one of Supplementary notes 1 to 10.

(Supplementary note 12)

A processing method including:
inputting image data acquired by a shooting means for shooting a display object;
inputting image data acquisition information when the image data is acquired;
inputting three-dimensional data acquired by a scanning means for scanning the display object;
determining a position and line-of-sight direction of a viewpoint in the three-dimensional data based on the position and shooting direction of the shooting means in the image data acquisition information and generating a viewpoint image that projects the three-dimensional data onto a surface orthogonal to the line-of-sight direction;
matching the image data with the viewpoint image and extracting a target area corresponding to the image data in the viewpoint image; and
generating parameters for displaying the target area.

(Supplementary note 13)

The processing method according to Supplementary note 12, further including displaying the three-dimensional data according to the parameters.

(Supplementary note 14)

The processing method according to Supplementary note 13, further including displaying the three-dimensional data alongside the image data when displaying the three-dimensional data according to the parameters.

(Supplementary note 15)

The processing method according to Supplementary note 13 or 14, further including displaying the three-dimensional data in synchronization with the image data when displaying the three-dimensional data according to the parameters.

(Supplementary note 16)

The processing method according to any one of Supplementary notes 13 to 15, further including holding screen setting information of a display screen on which the target area is to be displayed,
in which the parameters include the screen setting information.

(Supplementary note 17)

The processing method according to any one of Supplementary notes 12 to 16, in which the target area includes horizontal and vertical ranges orthogonal to the line-of-sight direction and a depth range along the line-of-sight direction.

(Supplementary note 18)

The processing method according to any one of Supplementary notes 12 to 17, further including:
holding the image data; and
inputting the held image data.

(Supplementary note 19)

The processing method according to any one of Supplementary notes 12 to 18, further including:
holding the image data acquisition information; and
inputting the held image data acquisition information.

(Supplementary note 20)

The processing method according to any one of Supplementary notes 12 to 19, further including:
holding the three-dimensional data; and
inputting the held three-dimensional data.

(Supplementary note 21)

The processing method according to any one of Supplementary notes 12 to 20, in which the parameters include at least one of: a width of a GUI screen, a height of the GUI screen, coordinates of the shooting and scanning means in a world coordinate system, a shooting direction vector of the shooting means, a line-of-sight direction vector of the scanning means, a vector indicating an upward direction of the shooting and scanning means, a display range in a depth direction, and FOV.

(Supplementary note 22)

The processing method according to any one of Supplementary notes 12 to 21, further including causing a three-dimensional data acquisition device configured to acquire the three-dimensional data by the scanning means for scanning the display object, to acquire the three-dimensional data.

(Supplementary note 23)

A non-transitory computer readable medium storing a program configured to cause a computer to execute:
inputting image data acquired by a shooting means for shooting a display object;
inputting image data acquisition information when the image data is acquired;
inputting three-dimensional data acquired by a scanning means for scanning the display object;
determining a position and line-of-sight direction of a viewpoint in the three-dimensional data based on the position and shooting direction of the shooting means in the image data acquisition information and generating a viewpoint image that projects the three-dimensional data onto a surface orthogonal to the line-of-sight direction;
matching the image data with the viewpoint image and extracting a target area corresponding to the image data in the viewpoint image; and
generating parameters for displaying the target area.

(Supplementary note 24)

The non-transitory computer readable medium storing a program according to Supplementary note 23, further causing a computer to execute displaying the three-dimensional data according to the parameters.

(Supplementary note 25)

The non-transitory computer readable medium storing a program according to Supplementary note 24, further causing a computer to execute displaying the three-dimensional data alongside the image data when displaying the three-dimensional data according to the parameters.

(Supplementary note 26)

The non-transitory computer readable medium storing a program according to Supplementary note 24 or 25, further causing a computer to execute displaying the three-dimensional data in synchronization with the image data when displaying the three-dimensional data according to the parameters.

(Supplementary note 27)

The non-transitory computer readable medium storing a program according to any one of Supplementary notes 24 to 26, further causing a computer to execute:
holding screen setting information of a display screen on which the target area is displayed; and
making the parameters include the screen setting information.

(Supplementary note 28)

The non-transitory computer readable medium storing a program according to any one of Supplementary notes 23 to 27, further causing a computer to execute making the target area include horizontal and vertical ranges orthogonal to the line-of-sight direction and a depth range along the line-of-sight direction.

(Supplementary note 29)

The non-transitory computer readable medium storing a program according to any one of Supplementary notes 23 to 28, further causing a computer to execute:
holding the image data; and
inputting the held image data.

(Supplementary note 30)

The non-transitory computer readable medium storing a program according to any one of Supplementary notes 23 to 29, further causing a computer to execute:
holding the image data acquisition information; and
inputting the held image data acquisition information.

(Supplementary note 31)

The non-transitory computer readable medium storing a program according to any one of Supplementary note 23 to 30, further causing a computer to execute:
holding the three-dimensional data; and
inputting the held three-dimensional data.

(Supplementary note 32)

The non-transitory computer readable medium storing a program according to any one of Supplementary note 23 to 31, further causing a computer to execute making the parameters include at least one of: a width of a GUI screen, a height of the GUI screen, coordinates of the shooting and scanning means in a world coordinate system, a shooting direction vector of the shooting means, a line-of-sight direction vector of the scanning means, a vector indicating an upward direction of the shooting and scanning means, a display range in a depth direction, and FOV.

(Supplementary note 33)

The non-transitory computer readable medium storing a program according to any one of Supplementary notes 23 to 32, further causing a computer to execute making the three-dimensional data acquisition device, which acquires the three-dimensional data by the scanning means for scanning the display object, acquire the three-dimensional data.

In the above-described example, the program can be stored using various types of non-transitory computer readable media to be supplied to a computer. The non-transitory computer readable media include various types of tangible storage media. Examples of the non-transitory computer readable medium include a magnetic recording medium (for example, a flexible disk, a magnetic tape, or a hard disk drive), an optical magnetic recording medium (for example, a magneto-optical disk), a compact disc-read only memory (CD-ROM), a CD-R, a CD-R/W, and a semiconductor memory such as a mask ROM, a programmable ROM (PROM), an erasable PROM (EPROM), a flash ROM, or a random access memory (RAM). In addition, the program may be supplied to the computer by various types of transitory computer readable media. Examples of the transitory computer readable media include electric signals, optical signals, and electromagnetic waves. The transitory computer readable medium can provide the program to the computer via a wired communication line such as an electric wire and optical fibers or a wireless communication line.

### REFERENCE SIGNS LIST

10, 10a, 10b PROCESSING DEVICE
11 IMAGE DATA INPUT UNIT
11a IMAGE DATA HOLDING UNIT
12 IMAGE DATA ACQUISITION INFORMATION INPUT UNIT
12a IMAGE DATA ACQUISITION INFORMATION HOLDING UNIT
13 THREE-DIMENSIONAL DATA INPUT UNIT
13a THREE-DIMENSIONAL DATA HOLDING UNIT
14 VIEWPOINT IMAGE GENERATION UNIT
15 TARGET AREA EXTRACTION UNIT
16 THREE-DIMENSIONAL DATA DISPLAY PARAMETER GENERATION UNIT
17 DISPLAY UNIT
18 SCREEN SETTING HOLDING UNIT
20 IMAGE DATA
21 POSITION
22 SHOOTING DIRECTION
23 ANGLE OF VIEW
30 THREE-DIMENSIONAL DATA
31 POSITION
32 LINE-OF-SIGHT DIRECTION
33 SURFACE
34 VIEWPOINT IMAGE
35 TARGET AREA
40 LiDAR
DE DETECTION UNIT
EM LIGHT EMITTING UNIT
LB BEAM
OB MEASUREMENT OBJECT
RB REFLECTED LIGHT

What is claimed is:

1. A processing device comprising:
an image data input unit configured to which image data acquired by a shooting unit configured to shoot a display object is input;
an image data acquisition information input unit configured to which image data acquisition information when the image data is acquired is input;
a three-dimensional data input unit configured to which three-dimensional data acquired by a scanning unit configured to scan the display object is input;
a viewpoint image generation unit configured to generate a viewpoint image by determining a position and line-of-sight direction of a viewpoint in the three-dimensional data based on the position and shooting direction of the shooting unit in the image data acquisition information, and generating a viewpoint image that projects the three-dimensional data onto a surface orthogonal to the line-of-sight direction;
a target area extraction unit configured to match the image data with the viewpoint image and extracting a target area corresponding to the image data in the viewpoint image; and
a three-dimensional data display parameter generation unit configured to generate parameters for displaying the target area.

2. The processing device according to claim 1, further comprising a display unit configured to display the three-dimensional data according to the parameters.

3. The processing device according to claim 2, wherein the display unit displays the three-dimensional data alongside the image data.

4. The processing device according to claim 2, wherein the display unit displays the three-dimensional data in synchronization with the image data.

5. The processing device according to claim 2, wherein
the display unit further comprises a screen setting holding unit configured to hold screen setting information of a display screen on which the target area is displayed by the display unit, and
the parameters include the screen setting information.

6. The processing device according to claim 1, wherein the target area comprises horizontal and vertical ranges orthogonal to the line-of-sight direction, as well as a depth range along the line-of-sight direction.

7. The processing device according to claim 1, further comprising an image data holding unit configured to hold the image data,
wherein the image data is input to the image data input unit from the image data holding unit.

8. The processing device according to claim 1, further comprising an image data acquisition information holding unit configured to hold the image data acquisition information,
wherein the image data acquisition information is input to the image data acquisition information input unit from the image data acquisition information holding unit.

9. The processing device according to claim 1, further comprising a three-dimensional data holding unit configured to hold the three-dimensional data,
wherein the three-dimensional data is input to the three-dimensional data input unit from the three-dimensional data holding unit.

10. The processing device according to claim 1, wherein the parameters comprise at least one of: a width of a GUI screen, a height of the GUI screen, coordinates of the shooting and scanning unit in a world coordinate system, a shooting direction vector of the shooting unit, a line-of-sight direction vector of the scanning unit, a vector indicating an upward direction of the shooting and scanning unit, a display range in a depth direction, and FOV.

11. A processing system comprising:
a three-dimensional data acquisition device configured to acquire the three-dimensional data by the scanning unit configured to scan the display object; and
the processing device according to claim 1.

12. A processing method comprising:
inputting image data acquired by a shooting unit configured to shoot a display object;
inputting image data acquisition information when the image data is acquired;
inputting three-dimensional data acquired by a scanning unit configured to scan the display object;
determining a position and line-of-sight direction of a viewpoint in the three-dimensional data based on the position of the shooting unit and the shooting direction in the image data acquisition information and generating a viewpoint image that projects the three-dimensional data onto a surface orthogonal to the line-of-sight direction;
matching the image data with the viewpoint image and extracting a target area corresponding to the image data in the viewpoint image; and
generating parameters for displaying the target area.

13. The processing method according to claim 12, further comprising displaying the three-dimensional data according to the parameters.

14. The processing method according to claim 13, further comprising displaying the three-dimensional data alongside the image data when displaying the three-dimensional data according to the parameters.

15. The processing method according to claim 13, further comprising displaying the three-dimensional data in synchronization with the image data when displaying the three-dimensional data according to the parameters.

16. The processing method according to claim 13, further comprising holding screen setting information of a display screen on which the target area is to be displayed,
wherein the parameters include the screen setting information.

17. The processing method according to claim 12, wherein the target area comprises horizontal and vertical ranges orthogonal to the line-of-sight direction and a depth range along the line-of-sight direction.

18. The processing method according to claim 12, further comprising:
holding the image data; and
inputting the held image data.

19. The processing method according to claim 12, further comprising:
holding the image data acquisition information; and
inputting the held image data acquisition information.

20. The processing method according to claim 12, further comprising:
holding the three-dimensional data; and
inputting the held three-dimensional data.

21-33. (canceled)
